(19) United States
(12) Patent Application Publication
(10) Pub. No.: US 2005/0059781 A1
(43) Pub. Date: Mar. 17, 2005

(54) Polyvinylbutyral compositions and blends having enhanced surface properties and articles made therefrom

(76) Inventors: Win-Chung Lee, Parkersburg, WV (US); I. Wayne Wang, Vienna, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/877,547

(22) Filed: Jun. 25, 2004

Related U.S. Application Data
(60) Provisional application No. 60/483,336, filed on Jun. 28, 2003.

(51) Int. Cl. C08L 29/04

(52) U.S. Cl. 525/206; 525/232; 525/238; 525/241

(57) ABSTRACT

Polymer blended compositions toughened with polyvinylbutyral having enhanced adhesive surface properties, including enhanced surface adhesion and low surface gloss, are disclosed. Also disclosed are articles of manufacture comprising the compositions described herein.

This application claims the benefit of U.S. Provisional Application No. 60/483,336, filed Jun. 28, 2003.

### FIELD OF THE INVENTION

The present invention relates to blends of polyvinyl butyral (PVB) with acrylonitrilelbutad ienelstyrene (ABS) and/or polycarbonate (PC) and/or nylon. More particularly, the present invention relates to such blends, processes for the manufacture of such materials, and molded articles prepared therefrom.

### BACKGROUND OF THE INVENTION

ABS, normally a shinny resin molded into toys and housing for small appliances and other gadgets, is preferred sometimes as a mat material for computer housing and automotive internal panel applications, for example. ABS with low surface gloss can be produced by known methods. For example, ABS with large (>0.4 micron, preferably >1 micron in diameter) rubbery substrates specially prepared by bulk polymerization or other agglomerated techniques can produce an ABS with desired low gloss.

Plasticized PVB can be difficult to handle as a feed to a compounding extruder due to its inherent stickiness. Similarly PVB sheet is a material that can be difficult to work with because of the tendency to adhere to itself. Sheets of PVB can stick together, or bind, with such strength that it is very difficult to separate the layers. The irreversible nature of this self-adhesion by PVB is referred to in the art of PVB manufacture as “blocking” Once PVB “blocks”, process difficulties are encountered. This tendency to block can make manufacturing processes that incorporate PVB unnecessarily complex and difficult. Consequently, continuous processes in which PVB is handled either in sheet form or in small shredded pieces can be very expensive to run, and therefore are not practical.

Moreover, blends of PVB sheet or small shredded pieces with other materials can block in the same manner as homogenous PVB compositions. Such blends of PVB with other polymers can be difficult to obtain in a cost-effective manner. A preferred process for preparing blends of PVB with other polymers would utilize conventional loss-in-weight screw feeders, which are found throughout that industry.

Recent work in the field indicates that blends of PVB with polyethylene and grafted rubbers are sufficiently non-sticky that they can be fed into a compounding extruder. See for example, WO 02/12356 directed to a process for preparing pellets from PVB scrap material.

It is an object of the present invention to provide PVB-enhanced ABS and/or PC blended compositions having enhanced surface adhesion, making them suitable for use in a variety of applications.

### SUMMARY OF THE INVENTION

In one aspect, the present invention is an acrylonitrile/butadiene/styrene (ABS) composition comprising: (a) from about 1 to about 30 weight percent of a free-flowing toughener comprising from about 20 weight percent to about 95 weight percent polyvinyl butyral (PVB); (b) complimentally, 99 to 70 weight percent ABS; and, (c) optionally a coupling agent in an amount of up to 1.0 weight percent.

In another aspect, the present invention is an article obtained from an acrylonitrile/butadiene/styrene (ABS) composition comprising: (a) from about 1 to about 30 weight percent of a free-flowing toughener comprising from about 20 weight percent to about 95 weight percent polyvinyl butyral (PVB); (b) complimentally, 99 to 70 weight percent ABS; and, (c) optionally a coupling agent in an amount of up to 1.0 weight percent.

In still another aspect the present invention is a polycarbonate (PC) composition comprising: (a) from about 1 to about 30 weight percent of a free-flowing toughener comprising from about 20 weight percent to about 95 weight percent polyvinyl butyral (PVB); (b) complimentally, 99 to 70 weight percent PC; and, (c) optionally a coupling agent in an amount of up to 1.0 weight percent.

In yet another aspect, the present invention is an article obtained from a polycarbonate (PC) composition comprising: (a) from about 1 to about 30 weight percent of a free-flowing toughener comprising from about 20 weight percent to about 95 weight percent polyvinyl butyral (PVB); (b) complimentally, 99 to 70 weight percent PC; and, (c) optionally a coupling agent in an amount of up to 1.0 weight percent.

In still another aspect the present invention is a three polymer blend composition comprising: (a) from about I to about 30 weight percent of a free-flowing toughener comprising from about 20 weight percent to about 95 weight percent polyvinyl butyral (PVB); (b) a second polymer (P2); (c) a third polymer (P3); and (d) optionally a coupling agent in an amount of up to 1.0 weight percent, wherein the combined wt % of [(b)+(c)] is in the range of from about 70 to 99 wt %.

In yet another aspect, the present invention is an article obtained from a three polymer blend composition comprising: (a) from about 1 to about 30 weight percent of a free-flowing toughener comprising from about 20 weight percent to about 95 weight percent polyvinyl butyral (PVB); (b) a second polymer (P2); (c) a third polymer (P3); and (d) optionally a coupling agent in an amount of up to 1.0 weight percent, wherein the combined wt % of [(b)+(c)] is in the range of from about 70 to 99 wt %.

### DETAILED DESCRIPTION OF THE INVENTION

In one embodiment, the present invention is an ABS composition having low gloss surface properties. A composition of the present invention comprises a free-flowing PVB composition, as described in WO 0212356, as a toughener. The teachings of WO0212356 is hereby incorporated by reference. A composition of the present invention comprises from about 1 wt % to about 30 wt %, preferably from about 5 wt % to about 28 wt %, more preferably from about 6 wt % to about 25 wt %, and most preferably from about 7 wt % to about 25 wt % of a free-flowing PVB composition.

The toughener comprises from about 20 to about 95 wt %, preferably from about 40 wt % to about 95 wt %, more preferably from about 60 wt % to about 95 wt %, and most preferably from about 75 wt % to about 95 wt % PVB. The compositions and blends of this invention are typically prepared by blending the toughener with: ABS; PC; and/or a three polymer blend composition optionally a coupling agent and/or other ingredients to produce a toughened ABS composition, PC composition, and/or a toughened three polymer blend composition having enhanced surface properties.

The toughener comprises at least one component in addition to the PVB. Such other components can be monomeric or polymeric materials, or mixtures thereof. The other components can be selected from polymers and/or monomers that have reactive functionality, or non-reactive polymer and/or monomers such as, for example, polyethylene, polypropylene, polyvinylchloride, nylon, other thermoplastic materials, or mixtures thereof. Preferably the second component is a polymer composition that includes reactive functionality such as anhydride functionality, such as is available commercially from E. I. DuPont de Nemours and Company under the Fusabond® brand name, or carboxylic acid functionality. Fusabond® polymers are polyolefins having anhydride functionality. The other components are present in the toughener in amounts that are complimentary to the amount of PVB in the toughener, that is the amount required to account for 100 wt % of the composition.

Two-component polymer blends (that is, blends of toughener with one other polymer) of the present invention can include from about 70 to about 99 wt % of either ABS or PC. Three-component polymer blends (that is, blends of toughener with two other polymers) include the toughener and either PC or ABS with a third polymer component. The third polymer is selected from the group consisting of: polyamides and polyesters. The third component can also be either ABS or PC, that is, blends of PC/ABS/toughener; PC/polyamide/toughener; PC/polyester/toughener; ABS/polyamide/toughener; or ABS/polyester/toughener, for example, are contemplated herein. In a three-component blend, the two additional polymer components can be present in any complimentary amount with the toughener. The two additional polymer components can each independently be present in an amount of from about 10 wt % to about 90 wt %.

A coupling agent is optionally included in the composition of the present invention. The coupling agent enhances the adhesive surface properties of the toughened compositions of the present invention. The coupling agent can be a silane compound. Preferably the coupling compound is selected from the group consisting of: gamma-aminopropyltrimethoxysilane; gamma-aminopropyltriethoxysilane; N-2-aminopropyltrialkoxysilane; or N-(2-aminoethyl)-3-aminopropylmethyidialkoxysilane. When present, the coupling compound is preferably included in an amount of at least about 0.01 wt %. More preferably, the coupling agent is present in an amount of from about 0.1 to about 3 wt %. More preferably, the coupling agent is present in an amount of from about 0.3 wt % to about 2.0 wt %, and most preferably in an amount of from about 0.5 wt % to about 1.5 wt %. The coupling agent can be present as a coating or as a dispersed component in the composition. The coupling agent can function to enhance the adhesion between the toughened compositions of the present invention and a second polymer, such as a thermoplastic elastomer (TPE). TPE's can be desirable because of the soft feel of the polymer, and are also referred to herein as soft touch polymers.

In another embodiment, the present invention is a process for preparing the toughened compositions of the present invention. The toughener of the present invention can be obtained using the process described in WO 0212356, wherein PVB is combined with a second polymeric component to yield non-blocking pellets having a substantial amount of PVB. PVB is a commercially available product useful for imparting shatter-resistance to glass in myriad applications, among them windshields for automobiles and window glass in homes and buildings. The preparation of PVB is a well-known reaction between aldehyde and alcohol in an acid medium. A plasticizer can be used is conventional. Useful plasticizers are known and are commercially available compounds such as, for example, diesters of aliphatic diols with aliphatic carboxylic acids, e.g. tri-ethylene glycol di-2-ethylhexoate (3GO), or tetra-ethylene glycol di-n-heptanoate (4G7). Virgin plasticized PVB sheets (that is, PVB that is obtained first-hand from a manufacturer's roll) can be obtained commercially from DuPont under the brandname of BUTACITE®, for example. PVB can be obtained from other sources, as well, including excess PVB obtained from the edge trim from safety or architectural glass manufacturing operations, PVB recovered from scrap automotive or architectural glass, PVB not considered usable in other commercial applications, and other similar sources or mixtures of these sources. Any of these sources can be satisfactorily used without departing from the spirit and scope of this invention.

In a preferred embodiment, plasticized PVB and three other ingredients: (1) a reactive polymer such as a polymer having anhydride or carboxylic acid functionality; (2) a non-reactive polymer such as polyethylene, polypropylene, or ethylene/n-butyl acrylate/CO terpolymer; and (3) an antioxidant; are mixed in a batch process or a continuous process at an elevated temperature in the range of from about 100° C. to about 280° C., preferably from about 150° C. to about 220° C. to provide a homogeneous melt blend. This blend is dropped to a set of roll mills to mix further and press it into sheet form. A strip of the sheet is continuously fed to an extruder through a belt feeder. In the extruder, the mixture is melted again and pushed through a melt filter to remove any solid contamination. The clean melt is distributed to a die with multiple holes. An under water face cutter cuts those polymers from die face into pellets. The water quenches those pellets while cutting and carries them into a screen to separate them from the bulk water. Wet pellets are dried in a fluidized dryer before pack-out.

The pellets thus obtained can be mixed by melt-blending with suitable polyacetal compositions. For example, the toughened polyacetal blends suitable for use herein can be obtained by melt blending, or melt mixing in any suitable blending or mixing device, such as a Banbury blenders, Haake mixers, Farrell mixers, or extruders. Extruders can be either single screw or twin screw extruders with screws having various degrees of severity. Mixing or blending can be done at a temperature in the range of from about 100° C. to about 250° C., and preferably at a temperature in the range of from about 150° C. to about 230° C.

Toughened compositions of the present invention give compressive shear strength (CSS) values determined by Compressive Shear tests. Toughened compositions of the present invention having further enhanced adhesive properties are obtained by further incorporating a coupling or crosslinking agent with the toughened polymer composition. For example, a coupling agent such as Silquest A-1100® (gamma-aminopropyltriethoxysilane), which is commercially available from Crompton Corp., can be incorporated by either inclusion into the bulk of the toughened polymer composition, or by coating the surface of the toughened polymer composition. The coupling compound can be incorporated in either manner as an aqueous solution. The pH of the solution can be lowered using an acid such as acetic acid or citric acid, for example.

In another embodiment, the present invention is an article obtained from the polymer compositions of the present invention. Articles of the present invention include laminate articles, shaped articles, etc. Laminates comprising the polymer compositions of the present invention can be incorporated into various other articles such as, for example, cars, trains, automobiles, appliances, boats, acoustic tiles, acoustic flooring, walls, ceilings, roofing materials or other articles where sound damping, low surface gloss, and/or tough polymers are desirable.

In the practice of the present invention, % gloss for a surface is determined according to ASTM D523, modified as described hereinbelow. The compositions of the present invention can reduce gloss by at least about 1 % relative to a composition that is similar except for the inclusion of the gloss reducing composition. Preferably the reduction in gloss is at least about 2%, more preferably at least about 2.5%, and most preferably at least about 5%.

In a particularly preferred embodiment, polymer compositions of the present invention can be laminated to other polymeric materials, such as thermoplastic elastomers (TPEs). TPEs are thermoplastic materials that have rubber-like properties and are polymers which are soft to the touch. However, TPEs do not generally have good adhesion to rigid polymers. TPE laminates with the polymers of the present invention would eliminate this adhesion problem in many cases.

In another preferred embodiment, the polymer compositions of the present invention can be laminated with PVB to yield PVB laminates having substantial sound reduction properties.

In still another embodiment, laminates having at least two sheets comprising a polymer composition of the present invention adhered on the opposite surfaces of a PVB interlayer have improved and structural strength relative to one sheet of the polymer having twice the thickness of the laminate polymer sheets. Such laminates can find use in car door panels, boat hulls, or other similar uses to impart structure and strength.

### EXAMPLES

### Examples 1 to 3 and Control Example C1

Extrusion Process to Produce Polymer Blends and Physical Properties of the Blends

ECOCITE™,¹was melt blended together with ABS (Magnum® 3490, available commercially from Dow Chemical Corp.). The comparative example C1 included no Ecocite™. During the operation for melt blending the ingredients were charged to the blender using individually controlled loss-in-weight feeders. The mixture was compounded by melt blending in a 40 mm Werner & Pfleiderer co-rotating twin-screw extruder with a barrel temperature about 170 to 220° C. and a die temperature of about 220° C. All of the ingredients were fed into the first barrel section. Extrusion was carried out with a port under vacuum. The screw speed was 250 rpm and the total extruder feed rate was 150 pounds per hour.
¹Free flowing PVB pellets as prepared according to WO 0212356, available from E.I. DuPont de Nemours and Company (DuPont).

The resulting strand was quenched in water, cut into pellets, and sparged with nitrogen until cool. The moisture in the resulting pellets was adjusted to between 0.1 % and 0.2% by drying or adding additional water as required. Tensile bars were obtained by injection molding according to ATM D294 and measured for % Elongation at Break (EL-B) by ASTM D527, Tensile Strength at Break by ASTM D527, and Flex Modulus (F. Mod) by ISO 178 and the results recorded in Table 1.

Gloss Measurement

% Gloss reported in Table 1 was measured at 60 degrees by a modified ASTM D-523 method using a Novo-Gloss Meter made by Macbeth. The measurement followed ASTM D-523 except gloss was measured at the center of a 18 mm×29 mm end tab on two ISO bars and averaged. Gloss was measured on the non-gated end of the bars in order to prevent gate smear from influencing the measurement.

TABLE 1

| | | C1 | Ex 1 | Ex 2 | Ex 3 |
|---|---|---|---|---|---|
| Magnum ® 3490 | | 100 | 95 | 90 | 85 |
| ECOCITE ™ H | | 0 | 5 | 10 | 15 |
| DENSITY | | 1.05 | 1.05 | 1.05 | 1.06 |
| Melt Viscosity | | | | | |
| 280 C. 1/1000 s-1 | Pa-s | 231.5 | 212.9 | 195.1 | 180.5 |
| Tensile Properties | | | | | |
| % Elongation | % | 23.2 | 40.2 | 27.1 | 15.9 |
| Tensile Strength | MPa | 39.0 | 34.3 | 32.1 | 29.8 |
| | psi | 5665 | 4971 | 4660 | 4321 |
| Flexural Modulus | GPa | 2.527 | 2.493 | 2.4 | 2.33 |
| | psi | 366758 | 361882 | 348276 | 338188 |
| Avg Surface Gloss | % | 79.7 | 65.4 | 53.7 | 47.9 |

### Examples 4 to 6 and Comparative Example C2

The same process, procedures, and test methods in above Examples 1 to 3, & C1 were used for Examples 4-6 and Comparative Example C2 in Table 2 except Magnum® 3490 was replaced with Magnum® 9010.

TABLE 2

| | | C2 | Ex 4 | Ex 5 | Ex 6 |
|---|---|---|---|---|---|
| Magnum ® 9010 | | 100 | 95 | 90 | 85 |
| ECOCITE ™ H | | 0 | 5 | 10 | 15 |
| DENSITY | | 1.05 | 1.05 | 1.05 | 1.05 |
| Melt Viscosity @ | Pa-s | 216.5 | 198.9 | 180.8 | 171.2 |
| 280° C. 1/1000 s-1 | | | | | |
| Tensile Properties | | | | | |
| % Elongation | % | 25.6 | 24.7 | 23.4 | 13.9 |
| Tensile Strength | MPa | 36.9 | 33.7 | 30.7 | 29.0 |
| | psi | 5355 | 4898 | 4456 | 4205 |
| Flexural Modulus | GPa | 2.485 | 2.437 | 2.422 | 2.325 |
| | psi | 360595 | 353761 | 351490 | 337468 |
| Avg Surface Gloss | % | 78.6 | 66.8 | 56.7 | 54.2 |

### Examples 7 to 9 and Comparative Example C3

The same process, procedures, and test methods in above Examples 1 to 3, & C1 were used for Examples 7-9 and Comparative Example C3 in Table 3 except Magnum® 3490 was replaced with Magnum® 9035.

Modified Compressive Shear Stress (CSS) Test for Adhesion Force of Laminated Polymer Plate

Square (5″×5″) plaques of 2 mm thickness were molded in an injection molding machine according to ISO test method 294. PVB sheeting was sandwiched between two plagues in a humidity controlled room (relative humidity: 23% RH). After being autoclaved at 135 c for 20 minutes, the 5″×5″ laminated polymer plate was cut to obtain six 1″×1″ squares from the center plate. The six squares were dried in a vacuum oven at 60° C. overnight. Each square was sheared at 45 degree angle in an Instron in a humidity controlled room (relative humidity: 50% RH). Force in pound per inch required to shear the square apart (CSS) was recorded. Average of those six squares and standard deviation were calculated for each sample and recorded in Table 3. In some cases, Silane or Silane with acid such as Acetic or Citric was coated on the surface of PVB sheeting before lamination.

TABLE 3

| | | C3 | Ex 7 | Ex 8 | Ex 9 |
|---|---|---|---|---|---|
| Magnum ® 9035 | | 100 | 95 | 90 | 85 |
| ECOCITE ™ H | | 0 | 5 | 10 | 15 |
| DENSITY | | 1.05 | 1.05 | 1.05 | 1.05 |
| Melt Viscosity | | | | | |
| 280 C. 1/1000 s-1 | Pa-s | 220.5 | 211.3 | 194.7 | 177 |
| Tensile Properties | | | | | |
| % Elongation | % | 24.5 | 24.9 | 10.5 | 4.7 |
| Tensile Strength | MPa | 34.3 | 31.0 | 29.3 | 29.7 |
| | psi | 4976 | 4501 | 4252 | 4314 |
| Flexural Modulus | GPa | 2.3 | 2.2 | 2.2 | 2.1 |
| | psi | 331308 | 325673 | 318416 | 311365 |
| Avg Surface | % | 76.8 | 71.6 | 66.6 | 63.8 |
| Gloss | | | | | |
| Avg CSS - psi | | 0 | | | 88.2 |
| CSS Std Dev - psi | | - | | | 55.5 |

Coated with Silane on surface

| | | |
|---|---|---|
| Avg CSS - psi | 1274.7 | 1403.3 |
| CSS Std Dev - psi | 467.7 | 169.7 |

Coated with Silane & Acetic Acid on surface

| | |
|---|---|
| Avg CSS - psi | 545.2 |
| CSS Std Dev - psi | 170.1 |

Coated with Silane and Citric Acid on surface

| | |
|---|---|
| Avg CSS - psi | 731.6 |
| CSS Std Dev - psi | 286.5 |

### Examples 10 to 11 and Comparative Example C4

The same process, procedures, and test methods in above Examples 7 to 9 & C3 were used for Examples 10-11 and Comparative 10 Example C4 in Table 4 except Magnum® 3490 was replaced with Magnum® 3490 and nylon-6 (Ultramid® B-3, available commercially from BASF Corp.) was added in a separate feeder.

TABLE 4

| | | C4 | Ex 10 | Ex 11 |
|---|---|---|---|---|
| Ultramid ® B-3 | | 70 | 63 | 56 |
| Magnum ® 9035 | | 30 | 27 | 24 |
| ECOCITE ™ H | | 0 | 10 | 20 |
| DENSITY | | 1.1 | 1.1 | 1.1 |
| Melt Viscosity | | | | |
| 280 C. 1/1000 s-1 | Pa-s | 192.9 | 174.9 | 156.3 |
| Tensile Properties | | | | |
| % Elongation | % | 8.6 | 14.2 | 16.2 |
| Tensile Strength | MPa | 63.2 | 46.6 | 36.4 |
| | psi | 9172 | 6763 | 5282 |
| Flexural Modulus | GPa | 2.7 | 2.5 | 2.3 |
| | psi | 390342 | 359893 | 336244 |
| Avg Surface Gloss | % | 69.3 | 59.0 | 59.7 |

Coated with Silane & Acetic Acid on surface

| | | | |
|---|---|---|---|
| Avg CSS - psi | 1753.5 | 1554.9 | 1066.1 |
| CSS Std Dev - psi | 361.5 | 281.4 | 52.5 |

Coated with Silane and Citric Acid on surface

| | | | |
|---|---|---|---|
| Avg CSS - psi | 1747.3 | 1700.1 | 1134.2 |
| CSS Std Dev - psi | 495.4 | 388.7 | 190.6 |

### Examples 12 and Comparative Example C5

Instead of melt blending in a extruder, ECOCITE™ and polycarbonate (Makrolon® 3102, available commercially from Bayer Corp.) were blended before feeding to an injection molding machine for tensile bars and square (5″×5″) plaques of 2 mm thickness for CSS. The same test methods as in Examples 1 to 3 were used to measure all the physical properties in Table 5.

TABLE 5

| | | C5 | Ex 12 |
|---|---|---|---|
| PC Makrolon ® 3102 | | 100 | 95 |
| ECOCITE ™ H | | 0 | 5 |
| Tensile Properties | | | |
| % Elongation | % | 34.4 | 59.7 |
| Tensile Strength | MPa | 47.9 | 49.5 |
| | psi | 6948 | 7189 |
| Flexural Modulus | GPa | 2.3 | 2.3 |
| Avg Surface Gloss | % | 158.7 | 134.9 |

### Examples 13 to 16 and Comparative Example C6

The same process, procedures, and test methods in above Examples 12 & C5 were used for Examples 13-16 and Comparative Example C6 in Table 6 except polycarbonate Makrolon® was replaced with PC and ABS alloy (Bayblend® T45, available commercially from Bayer Corp.).

TABLE 6

| | | C6 | Ex 13 | Ex 14 | Ex 15 | Ex 16 |
|---|---|---|---|---|---|---|
| Bayblend ® T45 | | 100 | 95 | 90 | 85 | 70 |
| ECOCITE ™ H | | 0 | 5 | 10 | 15 | 30 |
| Tensile Properties | | | | | | |
| % Elongation | % | 37.539 | 5.157 | 4.559 | 6.121 | 3.87 |
| Tensile Strength | MPa | 36.3 | 37.5 | 37.4 | 37.2 | 36.6 |
| | psi | 5267.3 | 5435.7 | 5423.0 | 5393.5 | 5315.8 |
| Flexural Modulus | GPa | 1.99 | 1.93 | 1.97 | 1.96 | 1.96 |
| Avg Surface Gloss | % | 86.36 | 82.7 | 83.7 | 84.3 | 81.1 |
| Avg CSS - psi | | | 2148 | 1431 | 1269 | 1672 |
| CSS Std Dev - psi | | | 569 | 523 | 537 | 616 |

### Examples 17 and Comparative Example C7

The same process, procedures, and test methods in above Examples 12 & C5 were used for Examples 17 and Comparative Example C7 in Table 7 except polycarbonate Makrolon® was replaced with PC and PET alloy (Makroblend® UT400, available commercially from Bayer Corp.).

TABLE 7

| | | C7 | Ex 17 |
|---|---|---|---|
| Makroblend ® UT400 | | 100 | 95 |
| ECOCITE ™ H | | 0 | 5 |
| Tensile Properties | | | |
| % Elongation | % | 3.6 | 4.1 |
| Tensile Strength | MPa | 57.9 | 54.5 |
| | psi | 8408.9 | 7915.6 |
| Flexural Modulus | GPa | 2.3 | 2.3 |
| Avg Surface Gloss | % | 60.9 | 45.0 |
| Avg CSS - psi | | 2402 | 2258 |
| CSS Std Dev - psi | | 338 | 191 |

1. An acrylonitrile/butadiene/styrene (ABS) composition comprising: (a) from about 1 to about 30 weight percent of a free-flowing gloss reducing toughener comprising from about 20 weight percent to about 95 weight percent polyvinyl butyral (PVB); (b) complimentally, 99 to 70 weight percent ABS; and, (c) optionally a coupling agent in an amount of up to 1.0 weight percent.

2. An article obtained from an acrylonitrile/butadiene/styrene (ABS) composition comprising: (a) from about 1 to about 30 weight percent of a free-flowing gloss reducing toughener comprising from about 20 weight percent to about 95 weight percent polyvinyl butyral (PVB); (b) complimentally, 99 to 70 weight percent ABS; and, (c) optionally a coupling agent in an amount of up to 1.0 weight percent.

3. A polycarbonate (PC) composition comprising: (a) from about 1 to about 30 weight percent of a free-flowing gloss reducing toughener comprising from about 20 weight percent to about 95 weight percent polyvinyl butyral (PVB); (b) complimentally, 99 to 70 weight percent PC; and, (c) optionally a coupling agent in an amount of up to 1.0 weight percent.

4. An article obtained from a polycarbonate (PC) composition comprising: (a) from about 1 to about 30 weight percent of a free-flowing gloss reducing toughener comprising from about 20 weight percent to about 95 weight percent polyvinyl butyral (PVB); (b) complimentally, 99 to 70 weight percent PC; and, (c) optionally a coupling agent in an amount of up to 1.0 weight percent.

5. A three polymer blend composition comprising: (a) from about 1 to about 30 weight percent of a free-flowing gloss reducing toughener comprising from about 20 weight percent to about 95 weight percent polyvinyl butyral (PVB); (b) a second polymer (P2); (c) a third polymer (P3); and (d) optionally a coupling agent in an amount of up to 1.0 weight percent, wherein the combined wt % of [(b)+(c)] is in the range of from about 70 to 99 wt %.

6. The composition of claim 5 wherein P2 is ABS.

7. The composition of claim 6 wherein P3 is a polyester.

8. The composition of claim 7 wherein the polyester is selected from polybutylene terephthallic esters (PBT) and/or polyethylene terephthallic esters (PET).

9. The composition of claim 6 wherein P3 is a polyamide.

10. The composition of claim 6 wherein P3 is a PC.

11. The composition of claim 5 wherein P2 is PC.

12. The composition of claim 12 wherein P3 is polyester.

13. The composition of claim 12 wherein P3 is nylon.

14. The composition of claim 13 wherein the gloss reducing toughener comprises one or more polymers having anhydride functionality and one or more polymers having carboxylic acid functionality.

15. The composition of all claims 14 wherein the gloss reducing toughener further comprises a non-reactive polymer selected from the group consisting of polyethylene, polypropylene, polyvinylchloride, nylon, olefinic copolymers, and mixtures thereof.

16. The composition of claim 15 wherein the coupling agent is an aminosilane compound and is included in an amount of from about 0.1 to about 1 wt %.

17. The article of claim 16 wherein the article is a laminate formed from at least one sheet of polyvinyl butyral and at least one polymer sheet adjacent to the polyvinyl butyral wherein the at least one sheet is obtained from the composition of claim 16, and wherein the compressive shear strength of the laminate is at least 450 pounds per square inch (psi).

18. The laminate of claim 17 wherein the laminate has sound damping properties.

19. An article comprising a laminate of claim 17.

20. The article of claim 17 wherein the article is: a boat; a car; a train; an airplane; a roof; a wall; a building; a tool; an appliance.

21. The article of claim 17 wherein the article is a button or switch on: electronic equipment or an electronic device; a stereo; a compact disc player; a telephone; a television; a remote control; a computer; a keypad; or a touch-screen.

22. The article of claim 17 wherein the article is formed by an injection molding or a press molding process.

23. The article of claim 17 having no filler and a reduction of surface gloss of at least about 1 % from the composition without the gloss reducing toughener.

24. A process for increasing the adhesion of the polymer composition of claim 1 comprising the step of including a silane coupling agent.

25. The process of claim 24 wherein the coupling agent is applied to the surface of the polymer composition or the PVB sheeting.

26. The process of claim 24 wherein the coupling agent is applied as an aqueous solution at a pH of less than 7.
